(19) United States
(12) Patent Application Publication
(10) Pub. No.: US 2015/0051964 A1
(43) Pub. Date: Feb. 19, 2015

(54) PROVIDING OFFERS FOR LOCAL DISCOUNTED GOODS AND SERVICES

(71) Applicant: Wizhunt Locals, Inc., Lewisville, TX (US)

(72) Inventor: Scott Eugene Hunt, Lewisville, TX (US)

(73) Assignee: Wizhunt Locals, Inc., Lewisville, TX (US)

(21) Appl. No.: 13/968,249

(22) Filed: Aug. 15, 2013

(51) Int. Cl. G06Q 30/02; G06Q 20/38

(52) U.S. Cl. CPC G06Q 30/0261; G06Q 30/0239; G06Q 20/387
USPC 705/14.39; 705/14.58

(57) ABSTRACT

A method and data processing system provide offers for discounted goods or services. The method includes generating a list of offers for discounted goods or services. The method includes generating an identification of at least one of a current number of selections of an offer or a number of remaining selections available for the offer. The method includes sending, for a selection of the offer by a user, at least a unique identifier for the offer to the user without requesting payment from the user for the selection of the offer and updating the current number of selections or the number of remaining selections available. The method includes sending a notification of the selection and the unique identifier for the selected offer to a seller of the discounted goods or services. Additionally, the method includes requesting payment from the seller for the selection of the offer by the user.

### TECHNICAL FIELD

The present disclosure relates generally to offers for discounted goods and services and, more specifically, to systems and methods for providing such offers.

### BACKGROUND

In online marketplaces, sellers are often looking to sell goods and services to as many consumers as possible, and consumers are often looking to purchase goods and services at affordable prices. In order to gain more customers, sellers often engage in advertising campaigns to gain customer recognition and engage customers with discounted prices. Recently, several “deals” websites have emerged offering potential customers significant discounts to try a seller's goods or services. In exchange for receiving the “deal,” the customer often pays an up-front discounted price for the “deal” to the deals website before traveling to the seller's business. In this scenario, the seller gains exposure to additional customers, and customers are given the promise of significantly discounted goods or services. However, most of these “deal” websites keep up to about 50% of the amount paid by the customer, leaving the seller with a small fraction of income in exchange for the goods or services rendered. This inequity often forces sellers to attempt to save costs in the quality of the goods or services leading to a poor customer experience and lack of profit for the seller.

Sellers also often use coupons as part of an advertising campaign to try to gain customer recognition and engage customers with discounted prices. However, sellers often have difficulty keeping track of the number of coupons issued and to whom the coupons were issued. Over proliferation of coupons and lack of knowledge of the customer base can frustrate advertising goals of tracking and increasing the number of customers while limiting the costs or amount of discounting needed to do so.

Accordingly, it would be advantageous to have systems and methods that take into account one or more of the issues discussed above as well as possibly other issues.

### SUMMARY

The different illustrative embodiments provide a method and data processing system for providing offers for discounted goods or services.

According to one exemplary embodiment of the present disclosure, a method for providing offers for discounted goods or services is provided. The method includes generating a list of offers including at least one offer for discounted goods or services. The selections of the offer are limited to a predetermined number. The method also includes generating an identification of at least one of a current number of selections of the at least one offer or a number of remaining selections available for the at least one offer. The method further includes sending, in response to identifying a selection of the at least one offer by a user, at least a unique identifier for the selected offer to the user without requesting payment from the user for the selection of the selected offer and updating at least one of the current number of selections or the number of remaining selections available. The method also includes sending a notification of the selection and the unique identifier for the selected offer to a seller of the discounted goods or services. Additionally, the method includes requesting payment from the seller of the discounted goods or services for the selection of the at least one offer by the user.

According to another exemplary embodiment of the present disclosure, a data processing system for providing offers for discounted goods or services is provided. The data processing system includes one or more storage devices configured to store program code and one or more processors configured to execute. The data processing system is configured to generate a list of offers including at least one offer for discounted goods or services, wherein selections of the offer is limited to a predetermined number. The data processing system is configured to generate an identification of at least one of a current number of selections of the at least one offer or a number of remaining selections available for the at least one offer. The data processing system is configured to generate, in response identifying a selection of the at least one offer by a user, at least a unique identifier for the selected offer for transmission to the user without requesting payment from the user for the selection of the selected offer and updating at least one of the current number of selections or the number of remaining selections available. The data processing system is configured to generate a notification of the selection and the unique identifier for the selected offer for transmission to a seller of the discounted goods or services. Additionally, the data processing system is configured to generate a request for payment from the seller of the discounted goods or services for the selection of the at least one offer.

According to another exemplary embodiment of the present disclosure, a method for providing offers for discounted goods or services is provided. The method includes generating a list of offers including at least one offer for discounted goods or services. Selections of the offer is limited to a predetermined number. The method includes generating an identification of at least one of a current number of selections of the at least one offer or a number of remaining selections available for the at least one offer. The method includes, in response to identifying a selection of the at least one offer by a user, generating at least one of a printable or displayable voucher for the selected offer including at least a unique identifier for the selected offer, sending at least one of the printable or displayable voucher to the user via at least one of an email account or a deals website account without requesting payment from the user for the selection of the selected offer, and updating at least one of the current number of selections or the number of remaining selections available. The selection of the at least one offer is a user selection to redeem the selected offer to purchase the discounted goods or services from the seller at a future time. The method includes sending a notification of the selection and the unique identifier for the selected offer to a seller of the discounted goods or services. Additionally, the method includes requesting payment from the seller of the discounted goods or services for the selection of the at least one offer by the user.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network of data processing systems in accordance with an illustrative embodiment;

FIG. 2 illustrates a block diagram of an offer management system in accordance with an illustrative embodiment;

FIG. 3 illustrates a screen capture of an exemplary user interface for providing information about offers to consumers in accordance with an illustrative embodiment;

FIG. 4 illustrates a screen capture of an exemplary user interface for providing detailed information about an offer to consumers in accordance with an illustrative embodiment;

FIG. 5 illustrates an example of a voucher for a redeemable offer in accordance with an illustrative embodiment;

FIG. 6 illustrates a screen capture of an exemplary user interface for management of user selected offers in accordance with an illustrative embodiment;

FIG. 7 illustrates a process for providing offers for discounted goods or services in accordance with an illustrative embodiment;

FIG. 8 illustrates a process for utilizing user feedback in providing offers for discounted goods or services in accordance with an illustrative embodiment; and

FIG. 9 illustrates a data processing system in accordance with an illustrative embodiment.

### DETAILED DESCRIPTION

The various figures and embodiments used to describe the principles of the present invention in this patent document are by way of illustration only and should not be construed in any way to limit the scope of the invention. Those skilled in the art will understand that the principles of the invention may be implemented in any type of suitably arranged device or system.

The different illustrative embodiments of the present disclosure recognize the tension between customers wanting affordable prices and sellers' expenses associated with their customers. Accordingly, various embodiments of the present disclosure provide offers of discounted goods and services to customers in a cost effective manner that enables sellers to increase their customer base while keeping track of the number of offers given and information about their advertising campaign successes or failures.

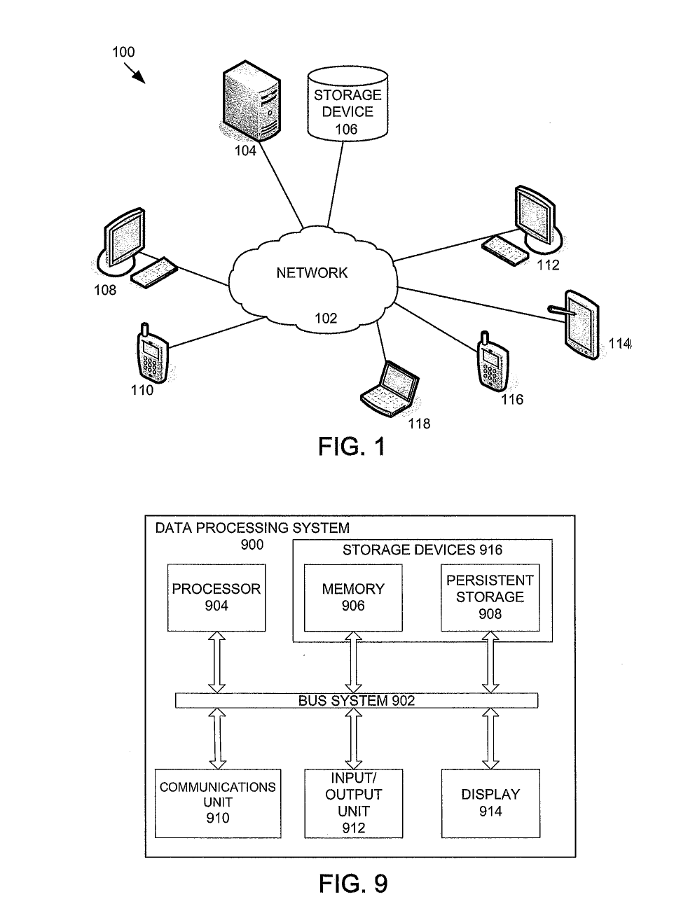

FIG. 1 illustrates an example networked system 100 of computing devices in which various systems and methods of the present disclosure can be implemented. The illustration of the networked system 100 is exemplary, and many modifications may be made to the arrangement illustrated in FIG. 1. In this illustrative embodiment, system 100 includes network 102, which is the medium used to provide communication links between various computers and other devices. Network 102 may include any suitable connections, such as wired, wireless, or fiber optic links. In some embodiments, network 102 represents at least a portion of the Internet and can include a worldwide collection of networks and gateways that use the Transmission Control Protocol/Internet Protocol (TCP/IP) suite of protocols to communicate with one another, although any other public and/or private network(s) could be used in system 100.

Elements of the present disclosure are implemented by server computer 104 and storage device 106 in connection with network 102. In this illustrative embodiment, server computer 104, in connection with storage device 106, provides computational resources for implementing an online marketplace via network 102. For example, server computer 104 may be a web-based server for hosting a website for an online marketplace. Storage device 106 may include one or more databases storing and organizing information about goods, services, sellers, consumers, and offers in connection with an online marketplace.

Client devices 108-118 also connect to network 102. Client devices 108-118 may be, for example, personal computers, network computers, personal digital assistants, tablet computers, mobile smart phones, or mobile computing devices. In this illustrative example, client devices 108 and 110 are data processing systems for sellers of products and services, while client devices 112-118 are data processing systems for consumers of products and services in the online marketplace provided over network 102. Server computer 104 provides information, such as webpage documents and application data, to client devices 112-118 as an interface to the online market place. In one example, separate interfaces are provided to seller data processing systems and consumer data processing systems via network 102.

Networked system 100 may include additional server computers, client devices, and other devices not shown. Networked system 100 also may be implemented as a number of different types of networks, such as, for example, the Internet, a local area network (LAN), or a wide area network (WAN). FIG. 1 is intended as an example and not as an architectural limitation for the different embodiments.

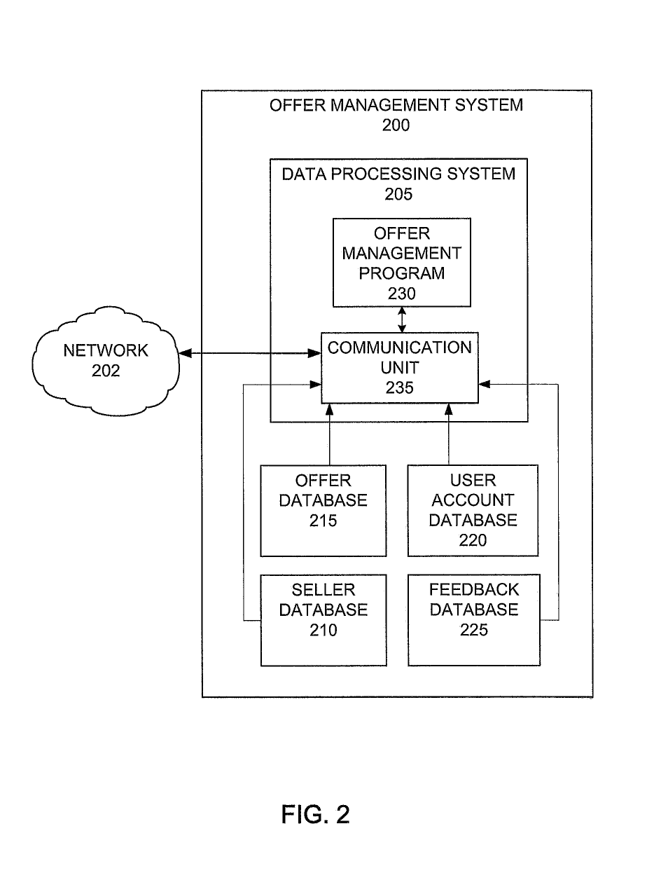

With reference now to FIG. 2, an illustration of a block diagram of an offer management system 200 is depicted in accordance with an illustrative embodiment. In this illustrative embodiment, the offer management system 200 includes a data processing system 205 in connection with a plurality of databases 210-225. In this illustrative example, data processing system 205 provides processing and software resources for providing accessibility over network 202. For example, data processing system 205 may be a web server (e.g., server computer 104) that hosts a website or mobile phone application for providing offers for goods and services that is accessible over the Internet by consumers (e.g., via client devices 112-118) and sellers (e.g., via client devices 108 or 110).

Offer management program 230 provides programming for data processing system 205 to implement the functionality of an online marketplace within offer management system 200. Communication unit 235 provides data communication between data processing system 205 and other elements within offer management system 200. For example, communication unit 235 may retrieve information from databases 210-225. Communication unit 235 may also provide content to web browsers and applications of consumers and sellers over network 202.

Offer management system 200 obtains, manages, and provides offers to various consumers in an online marketplace. When a seller of goods and services desires to market their goods and services, the offer management system 200 obtains information about the seller, the goods and/or services offered, and the nature of the offer via, for example, one of client devices 108 and 110. For example, offer management system 200 may provide a user interface for a business or seller of goods or services to set up and specify terms and conditions for offers. For example, the seller may provide location and business hour information of the seller, information about the type and quality of the goods/services offered by the seller, and terms and conditions for the offer. These terms and conditions may include, for example, without limitation, original and/or discounted prices of the goods/services, expiration date of the offer, limitations on total number of offer redemptions available, which may be specific to a particular seller location or for a period of time. The seller can specify that these limitations on the number of offers as limitations on the number redeemable per person, per party, per customer account, and/or per visit, etc. In other examples, the seller may select cities, states, and or postal codes of their business locations or customer locations to be included or excluded from their offer. In one example, a seller may select a particular city while removing specific postal codes from the offer. In these examples, the offer management system 200 may abstract this location specific offer information from the users or customers viewing the offers. For example, when generating the list of offers to display to the user, the offer management system 200 may include only the offers that are applicable to the user based on the user's and/or seller's location information.

The level of specificity in creating offers provided by offer management system 200 is beneficial to sellers for many reasons and allows a business/marketing professional to directly market their goods and/or services and allocate and deploy their advertisement and/or offer directly to whom they feel is their niche or intended target market. The seller may select from locational granularities, such as postal codes, that they feel the offer is more likely, suitable and/or profitable. The implementation of this methodology also allows individuals and companies to select certain locations based on numerous marketing demographics such as income per household and deploy these strategies in an effort to maximize their return on marketing investment.

In this illustrative example, the offer management system 200 may store this information in seller and offer databases 210 and 215, respectively. In these illustrative embodiments, the offers are offers for discounts on goods or services, which may include, for example, without limitation, food, business supplies, personal services, etc. The offers may be offers intended for individual consumers or business consumers. A user may sign up for and log in to an account maintained by the offer management system 200 via, for example, one of client devices 112-118. The offer management system 200 may obtain and maintain login and demographical information from account users as part of the sign-up process, for example, in user account database 220.

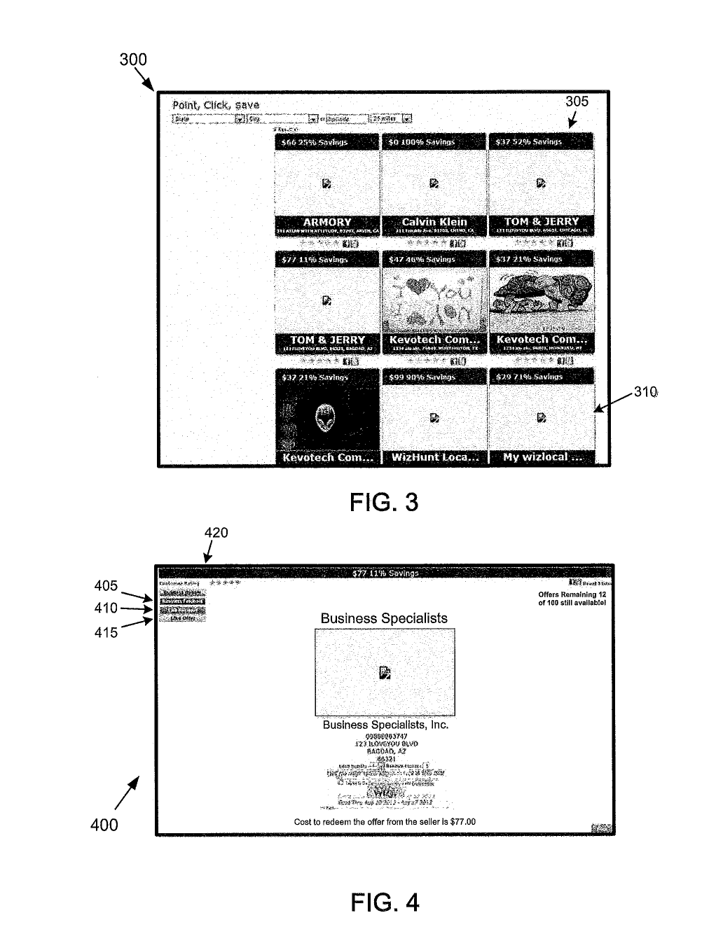

Offer management system 200 further provides a user interface for consumers to view and/or otherwise obtain information about the sellers and offers provided by offer management system 200. For example, the offer management system 200 may provide or host a website, web application, mobile application, or other type of user interface where consumers view and/or otherwise obtain information about the sellers and offers. FIG. 3 illustrates a screen capture of an exemplary user interface 300 for providing information about offers to consumers in accordance with an illustrative embodiment. In this illustrative example, user interface 300 displays information about various available offers for goods and services (e.g., restaurants, movies, sporting events, clothing, etc.) from various different sellers, businesses, or merchants in a list 305 of icons 310 for the offers. The information displayed in the offer icon 310 may include a picture representative of the goods or services, a description of the goods or services offered, a price of the offer, a percentage savings, etc.

The offer management system 200 allows users to search by offers based on several different criteria including, for example, without limitation, the user's location, the redemption location for the offer, the type or category of goods and services offered, ratings for the sellers, or by seller. The offer management system 200 may generate the list 305 automatically or in response to a user request. For example, the offer management system 200 may automatically generate the list upon a user logging in or accessing the website or application based on a user's location or user preferences for offers, types of goods or services, or preferred sellers. In one example, the offer management system 200 may identify the user's location from information from a mobile electronic device of the user (e.g., mobile phone) and automatically generate the list 305 of offers based on proximity to the user's location and possibly other criteria.

Upon a user selecting the offer icon 310 (e.g., mouse click, screen touch, etc.), the offer management system 200 may provide additional details about the offer and an option to select, reserve, or “lock-in” the offer for future redemption. FIG. 4 illustrates a screen capture of an exemplary user interface 400 for providing detailed information about an offer to consumers in accordance with an illustrative embodiment. In this illustrative example, user interface 400 displays information about a particular offer, such as, for example, a current number of redemptions for the offer, a number of remaining redemptions available for the offer, an address for the seller of the offer, terms and conditions of the offer, a period of time during which the offer is valid, an expiration date for the offer, a cost to redeem the offer, and a button to select, reserve, or otherwise “lock-in” the offer.

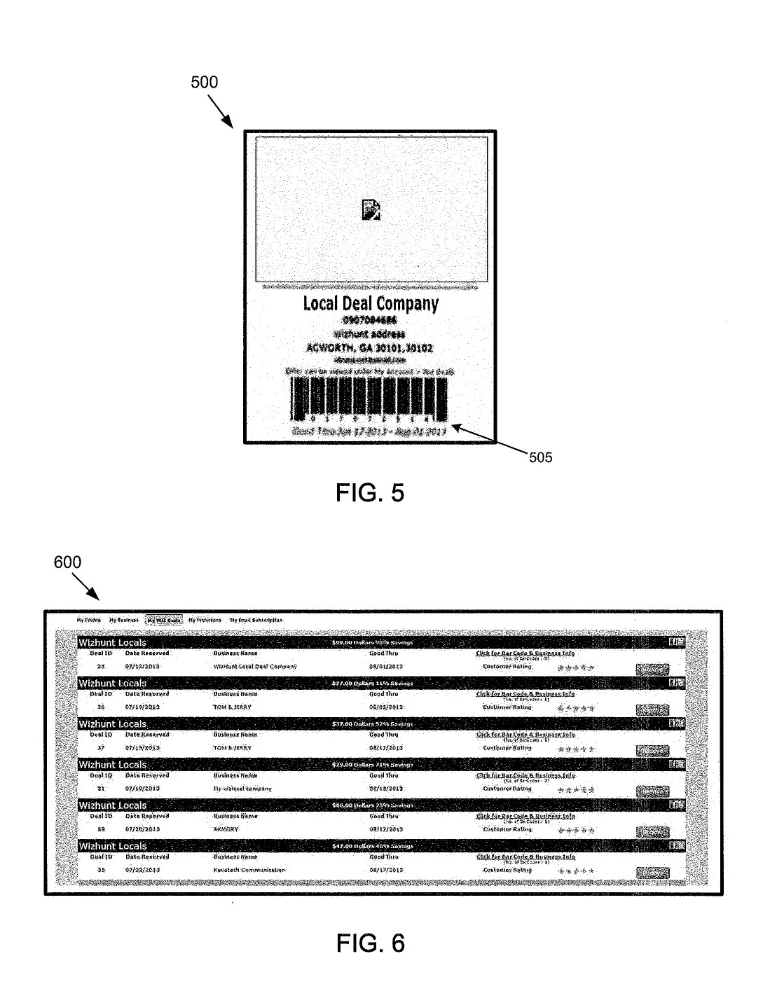

Upon selection of the offer, the offer management system 200 provides a voucher for the offer to the selector of the offer that includes an identifier that is unique to the selection. FIG. 5 illustrates one example of a voucher 500 for a redeemable offer in accordance with an illustrative embodiment. In this illustrative example, the voucher 500 includes information about the offer, such as, for example, an address for the seller of the offer, terms and conditions of the offer, a period of time during which the offer is valid, an expiration date for the offer, and a unique identifier 505 of the offer. The unique identifier 505 is unique to the particular selection of the offer by the consumer. In this manner, the offer management system 200, as well as the sellers, is able to keep track of the number of offers selected and/or the number of offers ultimately redeemed. The unique identifier 505 may include a barcode or Quick Response (QR) code for scanning by the seller at the time of redemption of the offer. The user of the unique identifier 505 provides quality controls to help eliminate overuse of the voucher by redeeming more offers than the seller allows per customer account. For example, if a seller grants only one offer per customer account, no matter how many times the customer attempts to select the same offer, that customer will continually receive the same unique identifier.

The offer management system 200 may provide the voucher 500 to the user via any type of communication method. For example, the offer management system 200 may provide the voucher 500 to an email account of the user, a social media account of the user, or a user account created with the offer management system 200 (e.g., information maintained in the user account database 220). The offer management system 200 may provide the voucher 500 for printing on paper or for display on a screen, for example, of a mobile device of the user for the user to redeem the offer from the seller.

FIG. 6 illustrates a screen capture of an exemplary user interface for management of user selected offers in accordance with an illustrative embodiment. In this illustrative example, the user interface 600 provides information to a user about different offers that the user has selected. For example, the offers may be ones that the user selected but has yet to use or redeem from the seller or all offers the user has previously selected including those previously redeemed. For example, the offer management system 200 provides, via user interface 600, information about selected offers, such as offer reservation date, name of the seller or business of the offer, offer savings percentage, cost to redeem offer from seller, a rating of the seller or business, and a link for the user to print or otherwise display the offer for redemption to the seller.

In some embodiments, the offer management system 200 may perform additional initiative offer management services to encourage use of the offer. For example, the offer management system 200 may provide reminders of when and where to redeem offers from the seller. For example, the offer management system 200 may provide a reminder (e.g., pop-up message, text message, email message) of some period of time (hours/days/weeks, etc.) before the expiration of the offer for the user to redeem the offer to remind the user before the offer expires. In another example, the offer management system 200 may provide a reminder based on a user's proximity to the business. For example, the user's account with the offer management system 200 may be integrated with a mobile phone, car navigation system, or other personal consumer electronic device of the user to identify and provide location information of the user, which the offer management system 200 can compare with at least one of the redemption locations for the seller or business to determine whether the user is within some threshold proximity. Upon such a determination, the offer management system 200 may provide to or cause the consumer device to provide a notification or reminder (e.g., pop-up message, text message, email message) of the offer and that the user is nearby a place where the offer may be redeemed. In some examples, the offer management system 200 may further compare a present time with hours of operation of the seller or redemption time period conditions to determine whether such a notification is appropriate (i.e., whether the offer can be redeemed at the present time). In these examples, any of the above-discussed reminders or services may be controlled or modified through user settings for the user's device or account.

In the various embodiments of the present disclosure, the offer management system 200 serves as an intermediary between sellers and consumers to offer affordable deals to consumers and increase customers for sellers. For example, the consumer is not charged to redeem the offer from the intermediary, but rather selects the offer and redeems the offer directly from the seller. In this manner, the consumer is not required to pay up-front for the offer, which decreases the complexity of completing an offer selection and the chances of online fraud. Similarly, because offers are selected at no upfront cost to the consumer, sensitive personal information about the customer is not revealed to the seller, which preserves customer privacy. Moreover, because the offer management system 200 does not have the overhead of processing transactions and managing payment and accounting manners, the costs for the services provided via the offer management system 200 are reduced. This allows the seller to remain profitable and incentivized to provide a positive consumer experience to the consumer upon redemption. Payment to the intermediary party for services rendered may occur from the seller based on the number of offers that are selected by users or redeemed, for example, on an impressions or encounters basis.

In various embodiments, the offer management system 200 provides tracking and data management for customer analytics. For example, the offer management system 200 tracks each selection of an offer to insure that a seller does not overextend itself beyond what the seller can afford to offer. In another example, the offer management system 200 provides real-time feedback on the success (or lack of success) of an advertising campaign. For example, the offer management system 200 may provide a user interface accessible by the seller to track in real-time when their offers are selected to determine, for example, how enticing particular offers are against other offers. The offer management system 200 may also provide demographical information (e.g., from account information obtained from the user account) about the sectors of such offers to the seller for the seller to determine, for example, which advertising campaigns are successful with which customer demographics. The offer management system 200 may also provide or allow sellers to determine and compare offer selections against offer redemptions. For example, the seller may compare time between selection and redemption and the percentage of redemptions to determine, for example, how excited consumers are about the particular offer.

In various embodiments, the offer management system 200 generates and manages feedback from users about various offers and sellers. For example, the offer management system 200 may request or allow users to submit feedback (e.g., a rating or comments) on particular offers and sellers, which may be stored in the feedback database 225. For example, the offer management system 200 may provide via user interface 400 options for a user to provide feedback on a business or seller (e.g., via “Business Feedback” button 405), “like” a business or seller (e.g., via “Like Business” button 410), or “like” an offer (e.g., via “Like Offer” button 415). The offer management system 200 may provide such feedback to sellers for the sellers to use in improving their performance and determining which offers to run. The offer management system 200 may also use such feedback in providing recommendations or notifications of offers to users. For example, if a user positively rates or “likes” (e.g., via a “Like Business” button 410) a seller or an offer, the offer management system 200 may monitor for a new offer from the same or a similar seller, a similar offer being run, or the seller rerunning the offer. Upon such a situation being identified, the offer management system 200 may send a notification (e.g., pop-up message, text message, email message, account notification, flag, etc.) that the user may be interested in the identified offer.

For example, in various embodiments, the offer management system 200 may remind customers who have previously selected the “Like Offer” button 415 for specific offer of that offer being rerun or a similar offer being run. The offer management system 200 will notify a customer having positively rated an offer (e.g., selected the “Like Offer” button 415) via email and/or system account when the business or seller reruns the specific marketing campaign. This is beneficial for many sellers as the seller can easily notice which offers are the most liked by customers. When customers have previously “liked” an offer the customer is notified of the offer being rerun. If the rerun offer is selected by the consumer, the business advertising campaign is deducted for the selected number of offers not exceeding the number allowed by the business per customer account, user, etc.

In other examples, the offer management system 200 may provide the seller a rating 420 in association with the offers from the sellers as illustrated, for example, in user interfaces 300, 400, and 600. This rating may be specific to the feedback given by the particular customer or an average of multiple customers.

In various embodiments, the offer management system 200 allows users to “share” any such offers, for example, via email, social media websites, etc. In one example, the offer management system 200 may generate an embeddable link or module for displaying the icon for the offer on a certain user's social media webpage for other viewers to learn of and select the offer directly through the social media website.

The illustration of offer management system 200 in FIG. 2 is not meant to imply physical or architectural limitations to the manner in which different illustrative embodiments may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, in some embodiments, functions performed in offer management system 200 may be performed by multiple data processing systems. For example, portions of the functions of the offer management system 200 above may be implemented by different servers or implemented within client devices of sellers and consumers. Offer management program 230 may include program code for different functions that are performed within different locations within offer management system 200. Additionally, data processing system 205 may include one of more processors that execute program code from offer management program 230 to implement functions of data processing system 205 within offer management system 200.

In another example, in some embodiments, databases 210-225 may be arranged in a number of different configurations. For example, the databases 210-225 may be a single database stored in a storage device within data processing system 205 or may be stored externally to offer management system 200 and connected to data processing system 205 via network 202. In other examples, individual databases in databases 210-225 may be split among one or more storage devices with some information from databases 210-225 stored locally and other information stored remotely. In another example, resources within offer management system 200 (e.g., data processing system 205, databases 210-225) may be implemented in a cloud computing environment where operations and functionality of offer management system 200 is performed at one or more remote locations and delivered to sellers and consumers via network 202.

Moreover, the exemplary screen captures or voucher illustrated in FIGS. 3-6 are for the purpose of providing examples of implementations of various embodiments of the present disclosure and are not in any way intended as limitations upon the various embodiments that can be implemented in accordance with the principles of the present disclosure.

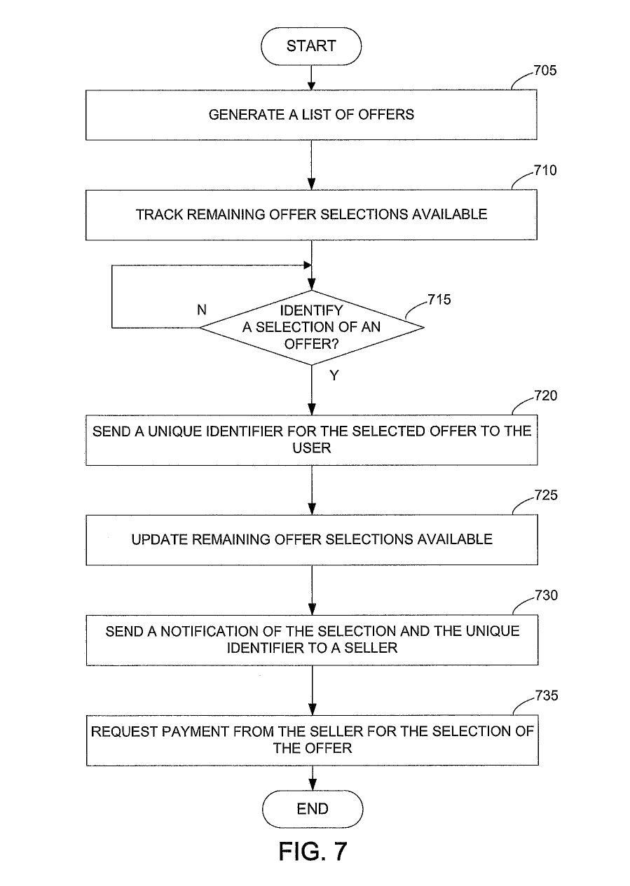

With reference now to FIG. 7, an illustration of a flowchart of a process for providing offers for discounted goods or services is depicted in accordance with an illustrative embodiment. This process can be performed, for example, by one or more data processing systems (e.g., server computer 104 or any of client devices 108-118 via network 102 in FIG. 1 or by data processing system 205 in FIG. 2) configured to perform acts described below, referred to in the singular as “the system.” The process can be implemented by executable instructions (e.g., offer management program 230) stored in a non-transitory computer-readable medium that causes one or more data processing systems to perform such a process.

The process begins with the system generating a list of offers (step 705). For example, in step 705, the system may generate a list of offers for discounted goods or services. These offers may be limited by a seller to a predetermined number of redemptions. The system may generate the list upon a user login, accessing a website page, or launching an application. The list of offers may be generated based on several criteria. For example, the list of offers may be generated based on a proximity of the identified location for the offers to a redemption location of the offers. In one such example, the system may identify the location for the offers automatically using a location signal generated by a mobile user device.

The system then tracks remaining offer selections available (step 710). For example, in step 710, the system tracks a current number of selections of the one offer and/or a number of remaining offer selections. Thereafter, the system determines whether a selection of an offer has occurred (step 715). For example, in step 715, the selection may be a user selection to redeem the selected offer to purchase the discounted goods or services from the seller at a future time.

If a selection of an offer has occurred, the system then sends a unique identifier for the selected offer to the user (step 720). As part of this step, the user is not charged for the selection of the offer. Rather, the selection, reservation, or locking-in is free of charge to the selector. The selector may then pay the seller the price indicated for the offer upon redemption of the offer at the seller's location. For example, in step 720, the system may generate a printable and/or displayable voucher for the selected offer including at least a unique identifier for the selected offer. The system may then send the printable and/or displayable voucher to the user via an email account or a deals website account. The user may present the offer for redemption in printed form or displayed on a mobile device.

Thereafter, the system updates remaining offer selections available (step 725). For example, in step 725, the system tracks and displays for both consumers and sellers the current number of selections and/or the number of selections of the offer remaining available. The system sends a notification of the selection and the unique identifier to a seller (step 730). For example, in step 730, the seller is notified of the user selection and unique identifier to track and validate legitimate offer redemptions.

Thereafter, the system requests payment from the seller for the selection of the offer (step 735). For example, in step 735, the system receives payment for offer referral from the seller, decreasing offer complexity with the consumer and passing overhead savings onto the seller.

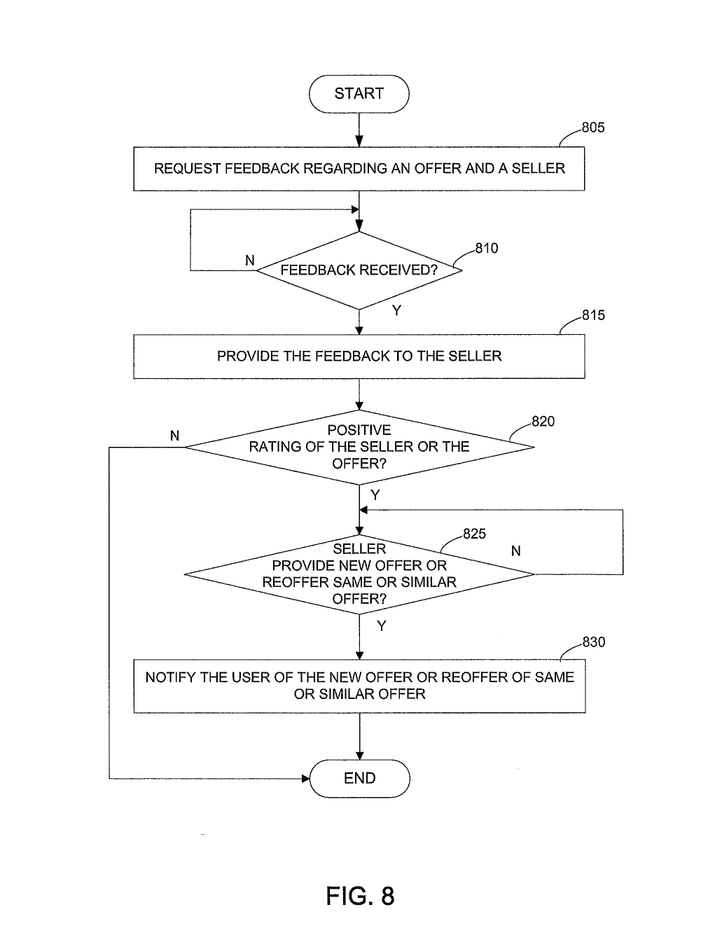

With reference now to FIG. 8, an illustration of a flowchart of a process for utilizing user feedback in providing offers for discounted goods or services is depicted in accordance with an illustrative embodiment. This process can be performed, for example, by one or more data processing systems (e.g., server computer 104 or any of client devices 108-118 via network 102 in FIG. 1 or by data processing system 205 in FIG. 2) configured to perform acts described below, referred to in the singular as “the system.” The process can be implemented by executable instructions (e.g., offer management program 230) stored in a non-transitory computer-readable medium that causes one or more data processing systems to perform such a process.

The process begins with the system requesting feedback regarding an offer and a seller (step 805). For example, in step 805, the system may request feedback from a user that had previously selected and redeemed an offer from a seller. The system then determines whether feedback has been received (step 810). If feedback has been received, the system may then provide the feedback to the seller (step 815). For example, in step 815, the system may provide and/or offer specific feedback to the seller to improve customer experience or use in deciding what type of offers to run in the future.

The system then determines whether the feedback includes a positive rating of the seller or the offer (step 820). For example, in step 820, the system may determine a rating for the seller to display to the user or other users in the future or to use in recommending future offers. The users may provide feedback of a positive rating for the offer and/or seller using the “Business Feedback” button 405, the “Like Business” button 410, or “Like Offer” button 415. If the feedback does not include a positive rating of the seller or offer in step 820, the process may end. If the feedback includes a positive rating of the seller, the system monitors offers to determine whether the seller provided a new offer or a reoffer for the same or similar offer (step 825). For example, in step 825, the system monitors the seller's offers, similar seller's offers, any rerunning of the offer, and/or any similar offers to determine offers the user may be interested in.

If the seller provided a new offer or a reoffer for the same or similar offer, the system then notifies the user of the new offer or reoffer of the same or similar offer (step 830). For example, in step 830, the system may provide a recommendation of an offer to the seller as a notification (e.g., pop-up message, text message, email message, account notification, flag, etc.) that the user may be interested in the identified offer.

The flowchart and block diagrams in the figures illustrate the architecture, functionality, and operation of possible implementations of systems, methods, and computer program products according to various illustrative embodiments. In this regard, each block in the flowchart or block diagrams may represent a module, segment, function, and/or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams.

In some embodiments, the function or functions noted in the block may occur out of the order noted in the figures. For example, in some cases, two blocks shown in succession may be executed substantially concurrently, or the blocks may sometimes be executed in the reverse order, depending upon the functionality involved. Also, other blocks may be added in addition to the illustrated blocks in a flowchart or block diagram.

FIG. 9 illustrates an example data processing system 900 in accordance with this disclosure. In this example, the data processing system 900 includes a bus system 902, which provides communications between a processor 904, a memory 906, a persistent storage 908, a communications unit 910, an input/output (I/O) unit 912, and a display 914. In these illustrative examples, data processing system 900 is an example of one implementation of server computer 104 and client devices 108-118 in FIG. 1. Data processing system 900 is also one example of data processing system 205 in FIG. 2.

Processor 904 process instructions for software that may be loaded into memory 906. Processor 904 may be a number of processors, a multi-processor core, or some other type of processor, depending on the particular implementation. Further, processor 904 may be implemented using a number of heterogeneous processor systems in which a main processor is present with secondary processors on a single chip. As another illustrative example, processor 904 may be a symmetric multi-processor system containing multiple processors of the same type.

Memory 906 and persistent storage 908 are examples of storage devices 916. A storage device is any piece of hardware that is capable of storing information, such as, for example, without limitation, data, program code in functional form, and/or other suitable information either on a temporary basis and/or a permanent basis. Memory 906, in these examples, may be, for example, a random access memory or any other suitable volatile or non-volatile storage device. For example, persistent storage 908 may contain one or more components or devices. Persistent storage 908 may be a hard drive, a flash memory, an optical disk, or some combination of the above. The media used by persistent storage 908 also may be removable. For example, a removable hard drive may be used for persistent storage 908.

Communications unit 910 provides for communications with other data processing systems or devices. In these examples, communications unit 910 is a network interface card. Communications unit 910 may provide communications through the use of either or both physical and wireless communications links.

Input/output unit 912 allows for input and output of data with other devices that may be connected to data processing system 900. For example, input/output unit 912 may provide a connection for user input through a keyboard, a mouse, and/or some other suitable input device. Further, input/output unit 912 may send output to a printer. Display 914 provides a mechanism to display information to a user.

Program code for an operating system, applications, or other programs (e.g., offer management program 230) may be located in storage devices 916, which are in communication with the processor 904 through the bus system 902. In some embodiments, the program code is in a functional form on the persistent storage 908. These instructions may be loaded into memory 906 for processing by processor 904. The processes of the different embodiments may be performed by processor 904 using computer-implemented instructions, which may be located in memory 906. For example, processor 904 may perform processes for one or more of the modules and/or devices described above.

In some embodiments, various functions described above are implemented or supported by a computer program product that is formed from computer-readable program code and that is embodied in a computer-readable medium. Program code for the computer program product may be located in a functional form on a computer-readable storage device that is selectively removable and may be loaded onto or transferred to data processing system 900 for processing by processor 904. In some illustrative embodiments, the program code may be downloaded over a network to persistent storage 908 from another device or data processing system for use within data processing system 900. For instance, program code stored in a computer-readable storage medium in a server data processing system may be downloaded over a network from the server to data processing system 900. The data processing system providing program code may be a server computer, a client computer, or some other device capable of storing and transmitting program code.

As will be appreciated by one skilled in the art, aspects of the present disclosure may take the form of a computer program product embodied in one or more computer-readable storage medium(s) having program code embodied thereon. A computer-readable storage medium may be, for example, without limitation, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. The program code may also be loaded for execution by a processor to provide processes for implementing the functions or operations described in the present disclosure.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of”, when used with a list of items, means that different combinations of one or more of the listed items may be used, and only one item in the list may be needed. For example, “at least one of item A, item B, and item C” may include, without limitation, item A or item A and item B.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing offers for discounted goods or services, the method comprising:
generating a list of offers including at least one offer for discounted goods or services, wherein selections of the at least one offer are limited to a predetermined number;
generating an identification of at least one of a current number of selections of the at least one offer or a number of remaining selections available for the at least one offer;
in response to identifying a selection of the at least one offer by a user, sending at least a unique identifier for the selected offer to the user without requesting payment from the user for the selection of the selected offer and updating at least one of the current number of selections or the number of remaining selections available;
sending a notification of the selection and the unique identifier for the selected offer to a seller of the discounted goods or services; and
requesting payment from the seller of the discounted goods or services for the selection of the at least one offer by the user.

2. The method of claim 1, wherein sending at least the unique identifier for the selected offer to the user without requesting payment from the user for the selection of the selected offer comprises:
generating at least one of a printable or displayable voucher for the selected offer including a barcode for the unique identifier; and
providing at least one of the printable or displayable voucher to the user via at least one of an email account or a deals account.

3. The method of claim 1 further comprising:
identifying the selection of the at least one offer as a user selection to redeem the selected offer to purchase the discounted goods or services from the seller at a future time.

4. The method of claim 1 further comprising:
in response to identifying the user positively rating at least one of (i) the seller of the discounted goods or services or (ii) the at least one offer, notifying the user, in response to at least one of (i) the seller providing a new offer or (ii) the at least one offer being reoffered at a future time.

5. The method of claim 1, wherein generating the list of offers comprises, in response to receiving an identification of a location for offers, generating the list of offers based on a proximity of the identified location for the offers to a redemption location of the offers.

6. The method of claim 5, wherein the location for the offers is identified using a location signal generated by a mobile user device.

7. The method of claim 1 further comprising:
requesting feedback regarding the selected offer and the seller from the user; and
providing the feedback to the seller for generating future offers.

8. The method of claim 1 further comprising:
in response to receiving a request to share an offer from the list of offers via a social media account, providing an embedded version of the offer for display on a social media website associated with the social media account.

9. A data processing system comprising one or more processors, one or more computer-readable memories, one or more computer-readable storage devices and program code stored on the one or more storage devices for execution by the one or more processors via the one or more memories that, when executed by the one or more processors, performs the method of claim 1.

10. A computer program product comprising one or more computer-readable, tangible storage devices and program code stored on the one or more storage devices that, when executed by one or more processors, performs the method of claim 1.

11. A data processing system for providing offers for discounted goods or services, the data processing system comprising:
one or more storage devices configured to store program code; and
one or more processors configured to execute the program code to:
generate a list of offers including at least one offer for discounted goods or services, wherein selections of the at least one offer are limited to a predetermined number;
generate an identification of at least one of a current number of selections of the at least one offer or a number of remaining selections available for the at least one offer;
generate, in response to identifying a selection of the at least one offer by a user, at least a unique identifier for the selected offer for transmission to the user without requesting payment from the user for the selection of the selected offer and updating at least one of the current number of selections or the number of remaining selections available;
generate a notification of the selection and the unique identifier for the selected offer for transmission to a seller of the discounted goods or services; and
generate a request for payment from the seller of the discounted goods or services for the selection of the at least one offer.

12. The data processing system of claim 11, wherein in generating at least the unique identifier for the selected offer for transmission to the user without requesting payment from the user for the selection of the selected offer, the one or more processors are configured to execute the program code to:
generate at least one of a printable or displayable voucher for the selected offer including a barcode for the unique identifier; and
instruct provision of at least one of the printable or displayable voucher to the user via at least one of an email account or a deals account.

13. The data processing system of claim 11, wherein the one or more processors are configured to execute the program code to identify the selection of the at least one offer as a user selection to redeem the selected offer to purchase the discounted goods or services from the seller at a future time.

14. The data processing system of claim 11, wherein the one or more processors are configured to execute the program code to generate, in response to identifying the user positively rating at least one of (i) the seller of the discounted goods or services or (ii) the at least one offer, a notification for the user, in response to at least one of (i) the seller providing a new offer or (ii) the at least one offer being reoffered at a future time.

15. The data processing system of claim 11, wherein in generating the list of offers, the one or more processors are configured to execute the program code to generate, in response to receiving an identification of a location for offers, the list of offers based on a proximity of the identified location for the offers to a redemption location of the offers.

16. The data processing system of claim 11, wherein the location for the offers is identified using a location signal generated by a mobile user device.

17. The data processing system of claim 11, wherein the one or more processors are configured to execute the program code to:
generate a request for feedback regarding the selected offer and the seller from the user; and
instruct provision of the feedback to the seller for generating future offers.

18. The data processing system of claim 11, wherein the one or more processors are configured to execute the program code to instruct, in response to receiving a request to share an offer from the list of offers via a social media account, provision of an embedded version of the offer for display on a social media website associated with the social media account.

19. A method for providing offers for discounted goods or services, the method comprising:
generating a list of offers including at least one offer for discounted goods or services, wherein selections of the at least one offer are limited to a predetermined number;
generating an identification of at least one of a current number of selections of the at least one offer or a number of remaining selections available for the at least one offer;
in response to identifying a selection of the at least one offer by a user, generating at least one of a printable or displayable voucher for the selected offer including at least a unique identifier for the selected offer, sending at least one of the printable or displayable voucher to the user via at least one of an email account or a deals website account without requesting payment from the user for the selection of the selected offer, and updating at least one of the current number of selections or the number of remaining selections available, wherein the selection of the at least one offer is a user selection to redeem the selected offer to purchase the discounted goods or services from the seller at a future time;
sending a notification of the selection and the unique identifier for the selected offer to a seller of the discounted goods or services; and
requesting payment from the seller of the discounted goods or services for the selection of the at least one offer by the user.

20. The method of claim 19 further comprising:
requesting feedback regarding the selected offer and the seller from the user;
providing the feedback to the seller for generating future offers; and
in response to identifying the user positively rating at least one of (i) the seller of the discounted goods or services or (ii) the at least one offer, notifying the user, in response to at least one of (i) the seller providing a new offer or (ii) the at least one offer being reoffered at a future time.
